(19) United States
(12) Patent Application Publication
(10) Pub. No.: US 2012/0291544 A1
(43) Pub. Date: Nov. 22, 2012

(54) ACTIVITY METER, CONTROL METHOD THEREOF, AND STORAGE MEDIUM

(75) Inventor: Yusuke KAWABE, Omihachiman-shi (JP)

(73) Assignee: OMRON HEALTHCARE CO., LTD., Muko-Shi (JP)

(21) Appl. No.: 13/565,386

(22) Filed: Aug. 2, 2012

Related U.S. Application Data
(63) Continuation of application No. PCT/JP2011/053512, filed on Feb. 18, 2011.

(30) Foreign Application Priority Data
Mar. 25, 2010 (JP) 2010-069949

(51) Int. Cl. G01P 15/00

(52) U.S. Cl. 73/488

(57) ABSTRACT

An activity meter includes an accelerometer for detecting movement of a body and a control unit connected to the accelerometer. The control unit determines segments corresponding to single cycles of body movement based on a detection output from the accelerometer, and based on a difference between a maximum value and a minimum value in the detection output from the accelerometer that correspond to the determined segments of the single cycles, specifies a type of activity performed in a predetermined period that includes the segments.

This is a Continuation of Application No. PCT/JP2011/05312 filed Feb. 18, 2011, which claims the benefit of Japanese Application No. 2010-069949 filed Mar. 25, 2010, The disclosure of the prior applications is hereby incorporated by reference herein in their entirety.

### TECHNICAL FIELD

The present invention relates to activity meters, and particularly relates to activity meters capable of more accurately specifying activity types.

### BACKGROUND ART

Thus far, various techniques for calculating a number of steps using the output of data detected by an accelerometer have been disclosed for use in activity meters.

For example, in Patent Literature 1 (JP 2009-223744A), a learning mode is provided, and a “single step” in normal walking is determined based on an acceleration waveform obtained when a user walks in the stated learning mode for the purpose of learning. Specifically, with respect to an accelerometer output obtained when a user walks for the purpose of learning, a set percentage of a maximum value relative to an average value is taken as a first threshold and a value corresponding to a set percentage of a minimum value to the average value is taken as a second threshold; then, a period that has been divided into a waveform of a single step (a division period) is taken as the cycle of a single step. Then, during normal walking (a measurement mode), a “single step” is determined only for a waveform that exceeds the first threshold and then drops below the second threshold, and in which the cycle is ±20% of the division period.

Meanwhile, Patent Literature 2 (JP 2005-038018A) discloses a technique for calculating a number of steps by calculating a sum of squares that is the sum of the squares of acceleration detection values Gx, Gy, and Gz obtained from a three-axis accelerometer. Specifically, a temporal change in the stated sum of squares is measured, and values greater than or equal to a certain threshold (or less than the threshold) are forcedly limited to the threshold by clipping the measurement result. Furthermore, components greater than or equal to a certain frequency threshold are cut through low-pass filtering. The number of steps is then calculated by counting peak values in the sum of squares for the accelerations processed in this manner.

In activity meters, it is important to accurately detect the activity type (walking, running, and so on) of a user in order to accurately calculate the total calories burned by that user. This is because the intensity of exercise differs depending on the activity type, and the number of calories burned per unit of time differs depending on the intensity of the exercise.

In light of this, Patent Literature 3 (JP 1408-131425A), for example, discloses a technique that measures the amplitude of a local maximal value (that is, an upward direction acceleration value) for each one-step segment in a set period (10 seconds, for example) and determines an activity type based on an average of those values. The activity type is determined to be “walking” if the average value is below the threshold, whereas the activity type is determined to be “running” if the average value is greater than or equal to the threshold.

Meanwhile, Patent Literature 4 (JP H06-044417) discloses a technique for determining (specifying) an activity type (walking, running, or the like) of a user using a detection unit having a particular structure. With the detection unit that detects a number of walking/running steps disclosed in Patent Literature 4, an operator is disposed, within an operator swinging space that includes spaces in the front and rear directions and up and down directions of the walking/running, so as to hang down from a spring, for example, and to be capable of swinging in the front and rear directions and up and down directions. Operator detection means that emit pulses upon being operated due to the operator moving are disposed, within the operator swinging space, in the rear-downward direction, the front-downward direction, and the central-upward direction relative to the walking/running direction. With this detection unit, the operator within the operator swinging space swings so as to trace a trajectory predicted in advance in accordance with the movement of the trunk of the user while walking. Through this, the multiple operator detection means operate in the predicted sequence when the user is walking, and pulses are emitted during this state of walking. However, when the user is running, the operator moves within the operator swinging space so as to trace a different trajectory than when walking, in accordance with the movement of the trunk of the user, which is different than the movement produced when the user is walking. This produces pulses having a different pattern than when the user is walking. In Patent Literature 4, walking/running are distinguished based on such differences in the detected pulses, and the numbers of walking/running steps are measured.

### CITATION LIST

### Patent Literature

| | |
|---|---|
| Patent Literature 1 | JP 2009-223744A |
| Patent Literature 2 | JP 2005-038018A |
| Patent Literature 3 | JP H08-131425A |
| Patent Literature 4 | JP H06-044417A |

### SUMMARY OF INVENTION

### Technical Problem

However, with such conventional activity meters, it can be expected that cases will occur where, for example, it is difficult for the activity type to be distinguished as walking if the user is running at a comparatively slow speed. Furthermore, it is thought that cases can occur where the activity type will be inaccurately specified when the predicted acceleration direction changes, such as when the activity meter is placed in a purse or the like and measurement is carried out in such as state.

Having been conceived in the light of such circumstances, it is an object of the present invention to accurately specify an activity type in an activity meter.

### Solution to Problem

An activity meter according to an aspect of the present invention includes an accelerometer for detecting movement of a body and a control unit connected to the accelerometer; the control unit determines segments corresponding to single cycles of body movement based on a detection output from the accelerometer, and based on a difference between a maximum value and a minimum value in the detection output from the accelerometer that correspond to the determined segments of the single cycles, specifies a type of activity performed in a predetermined period that includes the segments.

In addition, the control unit tentatively determines the type of activity performed in the segments, and determines that the type of activity that has been tentatively determined most often in the segments in the predetermined period is the type of activity in all the segments in the predetermined period.

Preferably, when tentatively determining the type of activity, the control unit tentatively determines the type of activity in the segments to be walking or running using a threshold for the difference between the maximum value and the minimum value.

An activity meter according to another aspect of the present invention includes an accelerometer for detecting movement of a body and a control unit connected to the accelerometer; the control unit determines segments corresponding to single cycles of body movement based on a detection output from the accelerometer, and based on a difference between a maximum value and a minimum value in the detection output from the accelerometer that correspond to the determined segments of the single cycles, specifies a type of activity performed in a predetermined period that includes the segments. In addition, the control unit calculates a frequency regarding the body movement by calculating the inverse number of the number of segments per unit of time, and specifies the type of activity based on the difference between the maximum value and minimum value and the frequency.

Preferably, the activity meter further includes a storage unit that stores a relational expression for distinguishing the type of activity based on the difference between the maximum value and minimum value and the frequency, and the control unit specifies the type of activity using the actual values of the difference between the maximum value and minimum value and the frequency, and the relational expression.

Preferably, the activity meter further includes a storage unit that stores a reference value for the difference between the maximum value and minimum value, the reference value being associated with the frequency, and the control unit specifies the activity type based on whether or not the difference between the maximum value and minimum value in the determined segments of the single cycles fulfills a specific condition relative to the reference value, stored in the storage unit, for the difference between the maximum value and minimum value associated with the calculated frequency.

A control method for an activity meter according to the present invention is control method for an activity meter including an accelerometer for detecting movement of a body, and includes a step of the activity meter determining segments corresponding to single cycles of body movement based on a detection output from the accelerometer, and a step of the activity meter specifying, based on a difference between a maximum value and a minimum value in the detection output from the accelerometer that correspond to the determined segments of the single cycles, a type of activity performed in a predetermined period that includes the segments; the step of specifying the type of activity performed in the predetermined period includes a step of tentatively determining the type of activity performed in the segments and a step of determining that the type of activity that has been tentatively determined most often in the segments in the predetermined period is the type of activity in all the segments in the predetermined period.

A storage medium according to the present invention is a storage medium in which is stored a control program executed by a computer of an activity meter including an accelerometer for detecting movement of a body, the control program causing the computer of the activity meter to execute a step of determining segments corresponding to single cycles of body movement based on a detection output from the accelerometer; and a step of specifying, based on a difference between a maximum value and a minimum value in the detection output from the accelerometer that correspond to the determined segments of the single cycles, a type of activity performed in a predetermined period that includes the segments; the step of specifying the type of activity performed in the predetermined period includes a step of tentatively determining the type of activity performed in the segments and a step of determining that the type of activity that has been tentatively determined most often in the segments in the predetermined period is the type of activity in all the segments in the predetermined period.

### Advantageous Effects of Invention

According to the present invention, an activity type can be specified with more accuracy.

### BRIEF DESCRIPTION OF DRAWINGS

FIG. 1 is an external view of an activity meter according to a first embodiment of the present invention.

FIGS. 2A and 2B are a diagram illustrating an example of a usage state of the activity meter shown in FIG. 1.

FIG. 3 is a block diagram illustrating the activity meter shown in FIG. 1.

FIG. 4 is a flowchart illustrating a step number management process executed by a control unit in the activity meter shown in FIG. 1.

FIG. 5 is a diagram illustrating an example of the detection output of an accelerometer for one step's worth of body movement in the activity meter shown in FIG. 1.

FIG. 6 is a block diagram illustrating an activity meter according to a second embodiment of the present invention.

FIG. 7 is a flowchart illustrating a step number management process executed by the control unit shown in FIG. 6.

FIG. 8 is a block diagram illustrating an activity meter according to a third embodiment of the present invention.

FIG. 9 is a diagram illustrating a frequency of the inverse number of a body movement number per unit of time, and an amplitude in each body movement of that frequency, in the activity meter shown in FIG. 8 when a user is walking and when the user is running.

FIG. 10 is a diagram in which a straight line dividing results between walking and running has been added to FIG. 9.

FIG. 11 is a flowchart illustrating a step number management process executed by the control unit shown in FIG. 8.

FIG. 12 is a block diagram illustrating an activity meter according to a fourth embodiment of the present invention.

FIG. 13 is a flowchart illustrating a step number management process executed by the control unit shown in FIG. 12.

### DESCRIPTION OF EMBODIMENTS

Hereinafter, embodiments of the present invention will be described in detail with reference to the drawings. Note that identical or corresponding elements in the diagrams will be given the same reference numerals, and descriptions thereof will not be repeated.

### First Embodiment

1. External Configuration of Activity Meter

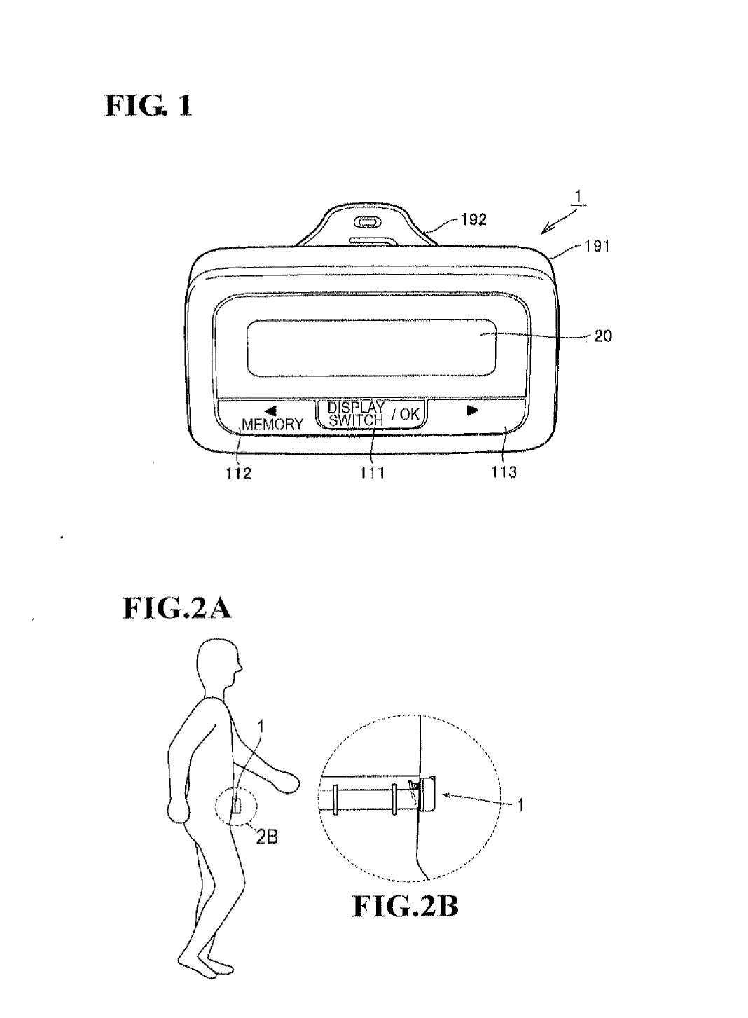

FIG. 1 is an external view of an activity meter 1 according to a first embodiment of the present invention.

As shown in FIG. 1, the activity meter 1 is primarily configured of a main body unit 191 and a clip unit 192. The clip unit 192 is provided for affixing the activity meter 1 to the clothing or the like of a user. Switches 111 to 113 that configure parts of an operation unit 11, which will be described later, and a display 20 that configures part of a display unit 15, are provided in the main body unit 191.

Although the display 20 is described as being configured of a liquid-crystal display (LCD) in the present embodiment, the display 20 is not limited thereto, and may be any type of display device, such as an electroluminescence (EL) device.

FIG. 2 is a diagram illustrating an example of a usage state of the activity meter 1 according to the present embodiment. As shown in FIG. 2, the activity meter 1 is affixed to, for example, a belt around the waist of the user using the clip unit 192. Note that the activity meter 1 is not limited to the state shown in FIG. 2, and may be affixed to another part of the user's body, or may be designed to be used by being placed in a purse or the like carried by the user as s/he walks.

2. Detailed Configuration of Activity Meter

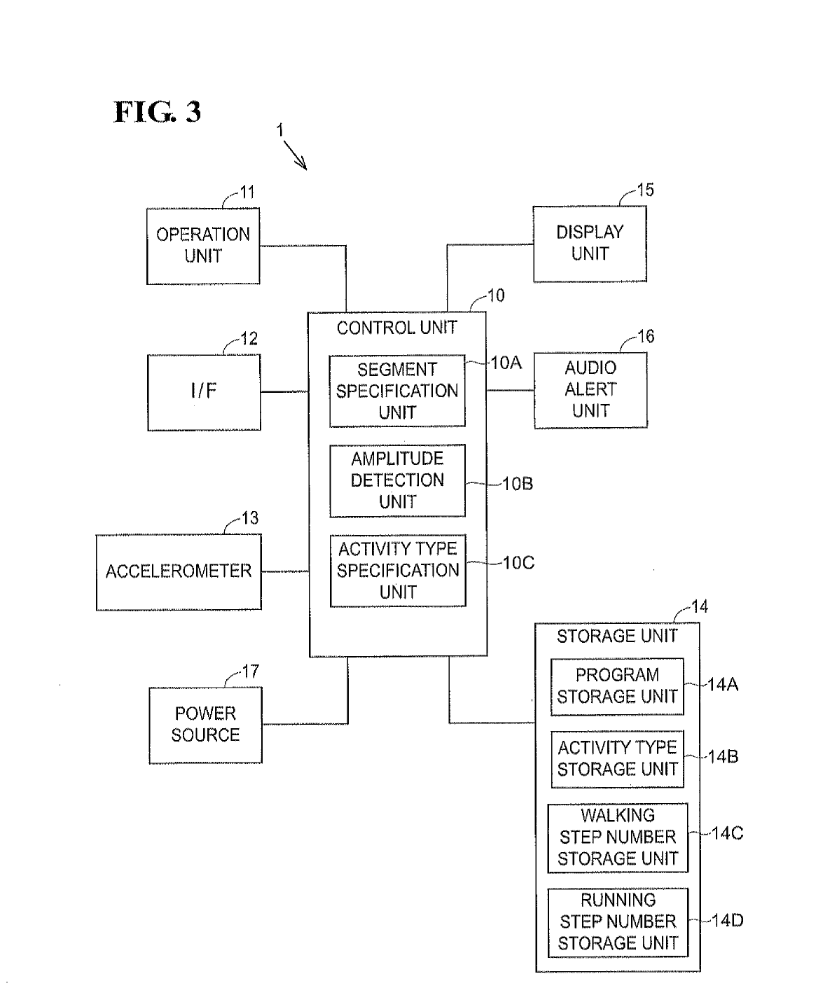

FIG. 3 is a block diagram illustrating the activity meter 1 according to the present embodiment. As shown in FIG. 3, the activity meter 1 includes a control unit 10, the operation unit 11, an interface (ICF) 12, an accelerometer 13, a storage unit 14, the display unit 15, an audio alert unit 16, and a power source 17. The power source 17 supplies power to the various elements of the activity meter 1.

The accelerometer 13 is an example of a detection unit that detects physical movement, and is a sensor that detects acceleration. In the activity meter 1, the accelerometer 13 is used for detecting acceleration resulting from physical activity such as walking, running, or the like.

The control unit 10 is configured of a microprocessor or the like, and in accordance with pre-recorded programs, functions so as to execute the following: measuring a number of steps; setting determination criteria; calculating a stride pitch (cycle), a step size, and so on; various types of computational processes regarding physical activity such as walking or running, such as specifying the type of the activity; controlling the display unit 15, the audio alert unit 16, and the like; and so on. Details of the functions of the control unit 10 will be given later.

The operation unit 11 is a user interface (including the switches 111 to 113) for performing operations such as switching modes (between a measurement mode and a learning mode), resetting the number of steps, inputting various types of setting values, and so on.

The I/F 12 is an external interface for exchanging data, through wireless or hard-wired communication, with an external device such as a personal computer. For example, the I/F 12 sends a result of measuring a number of steps, determination criteria used in that measurement, and so on to the external device.

The storage unit 14 is a non-volatile storage medium that stores data such as various setting values, a number of steps, a target exercise amount, a remaining exercise time, information regarding the user, and so on. The storage unit 14 may be provided as an integral part of the main body of the activity meter 1. At least part of the storage unit 14 (for example, a program storage unit 14A) may be provided in a form that can be handled independently, such as a storage medium that can be removed from the main body. Media that store programs in a non-volatile manner, such as the following, can be given as examples of such a storage medium: CD-ROMs (Compact Disc-Read Only Memory), DVD-ROMs (Digital Versatile Disk-Read Only Memory), USB (Universal Serial Bus) memories memory cards, FDs (Flexible Disk), hard disks, magnetic tape, cassette tapes, MOs (Magnetic Optical Disc), MDs (Mini Disc), IC (Integrated Circuit) cards (excluding memory cards), optical cards, mask ROMs, EPROMs, EEPROMs (Electronically Erasable Programmable Read-Only Memory), and so on.

The display unit 15 is a display device configured of the stated display 20 or the like, and displays information such as a measured number of steps, a target number of steps, or the like.

The audio alert unit 16 emits an operation sound, a stride pitch sound, a warning sound, and so on under the control of the control unit 10.

The control unit 10 includes: a segment specification unit 10A that specifies a single segment resulting from one step's worth of body movement in a signal obtained from the accelerometer 13; an amplitude detection unit 10B that detects the amplitude of the signal obtained from the accelerometer 13; and an activity type specification unit 10C that specifies the type of activity (walking, running, or the like) for each one step's worth of body movement. The amplitude detection unit 1013 detects the amplitude of the signal obtained from the accelerometer 13 in each segment specified by the segment specification unit 10A. The control unit 10 implements the functions of the stated various elements by, for example, the stated microprocessor executing the programs stored in the program storage unit 14A. Note that at least part of the control unit 10 may be realized by independent hardware resources.

The storage unit 14 includes: the program storage unit 14A that stores programs to be executed by the microprocessor of the control unit 10; an activity type storage unit 14B that stores the type of activity each “one step's worth of body movement” specified by the activity type specification unit 10C; a walking step number storage unit 14C that stores a number for which the activity type in the activity meter 1 has been specified as “walking”; and a running step number storage unit 14D that stores a number for which the type of activity has been specified as “running”.

3. Step Number Management Process

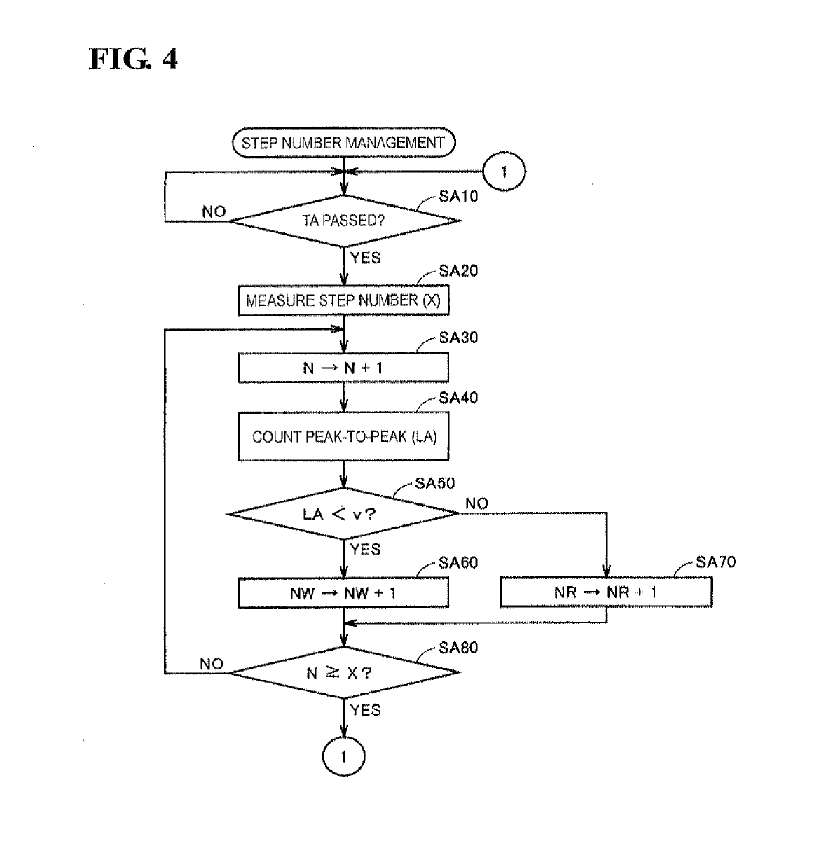

Next, a step number management process executed by the control unit 10 of the activity meter 1 according to the present embodiment will be described with reference to FIG. 4, which is a flowchart illustrating this process. Note that the step number management process is executed when the activity meter 1 is set to a mode for measuring a number of steps taken by the user (for example, the “measurement mode”).

As shown in FIG. 4, in the step number management process, the control unit 10 first determines, in step SA10, whether a predetermined set amount of time (TA) has passed following the start of the step number management process or following the execution of the previous process in step SA80, and advances the process to step SA20 if it has been determined that the set amount of time has passed. Note that although TA can be set to, for example, 20 seconds, the present embodiment is not limited thereto.

In step SA20, the control unit 10 measures a step number (X) in TA based on a signal outputted from the accelerometer 13 during the period TA, and advances the process to step SA30. A known technique such as that disclosed in Patent Literature 1 (JP 2009-223744A), Patent Literature 2 (JP 2005-038018A), or the like can be employed in the measurement of the step number in the period TA carried out in step SA20.

In step SA30, the control unit 10 updates a variable N used in the step number management process by adding 1 thereto, and then advances the process to step SA40. Note that the variable N is reset to its default value of 0 when the step number management process is started and when the process returns from step SA80, mentioned later, to step SA10.

In step SA40, the control unit 10 detects a difference (LA) between a maximum value and a minimum value in the detection output of the accelerometer 13 for the Nth step during the previous period TA, and then advances the process to step SA50.

In step SA50, the control unit 10 determines whether or not LA detected in step SA40 is less than a predetermined threshold v, advances the process to step SA60 if it has been determined that LA is lower than v, and advances the process to step SA70 if it has been determined that LA is greater than or equal to v.

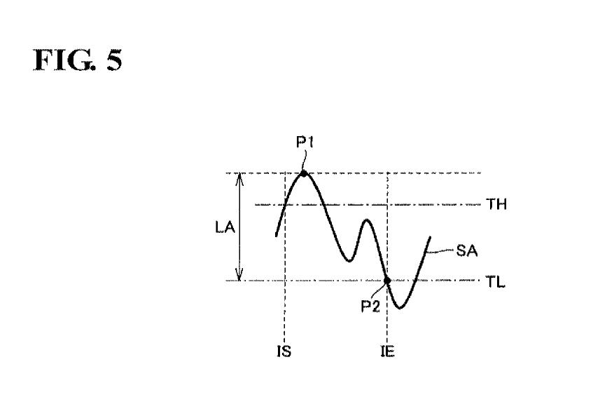

Here, the detection of LA will be described with reference to FIG. 5. FIG. 5 is a diagram illustrating an example of the detection output of the accelerometer 13 for one step's worth of body movement.

In FIG. 5, the detection output of the accelerometer 13 is represented by the graph SA. In the present embodiment, a first threshold value TH and a second threshold value TL are set for the detection signal of the accelerometer 13. A change in the detection signal of the accelerometer 13 from when the detection signal exceeds the first threshold value TH to when the detection signal drops below the second threshold value TL is taken as a signal change resulting from one step's worth of body movement. In the example shown in FIG. 5, a segment spanning from a time IS to a time IE is extracted as a segment that expresses a signal change resulting from one step's worth of body movement.

The segment specification unit 10A determines the segment expressing the signal change resulting from one step's worth of body movement described above with reference to FIG. 5. In other words, in the present embodiment, the segment specification unit 10A configures a determination unit that determines a segment corresponding to a single cycle of body movement from the detection output of the accelerometer.

In step SA40, the difference LA between the maximum value and the minimum value of the detection signal of the accelerometer 13 is detected for that segment. In the present specification, a difference between the output values of the accelerometer 13 at a point P1 corresponding to the maximum value and a point P2 corresponding to the minimum value is also called the amplitude of the detection signal of the accelerometer 13 in the segment that expresses the signal change resulting from one step's worth of body movement.

Returning to FIG. 4, in step SA60, assuming that the type of activity in the Nth step that is currently being processed is “walking”, the control unit 10 updates a walking step number NW stored in the walking step number storage unit 14C by adding 1 to that walking step number NW, and advances the process to step SA80.

On the other hand, in step SA70, assuming that the type of the activity in the Nth step that is currently being processed is “running”, the control unit 10 updates a running step number NR stored in the running step number storage unit 14D by adding 1 to that running step number NR, and advances the process to step SA80.

In step SA80, it is determined whether or not the variable N has reached the step number (X) measured in step SA20; if it is determined that the variable N has not reached the step number (X), the process is returned to step SA30, whereas if it is determined that the variable N has reached the step number (X), the process is returned to step SA 10.

Note that in the present specification, “step number X” refers to the number of segments in the detection output of the accelerometer 13 that have been determined to correspond to one step's worth of body movement, whereas “walking step number NW” refers to the number of one step's worth of body movements for which the activity type has been determined to be walking.

In the step number management process according to the present embodiment described thus far, the number of steps is counted each time the period TA passes, and the amplitude of the difference between the maximum value and the minimum value of the detection output from the accelerometer 13 (also called “peak to peak” as appropriate hereinafter) is detected for each segment expressing a signal change resulting from one step's worth of body movement; then, depending on whether or not that amplitude is greater than or equal to the threshold v, the one step's worth of body movement that is being processed is specified as resulting from walking or running.

Note that there is a general trend toward a system in which various program modules are prepared as part of a computer's operating system and application programs advance their processing by calling those modules as necessary in a predetermined arrangement. In such a case, the software itself used for implementing the activity meter according to the present embodiment does not include such modules, and the activity meter is first realized by running in tandem with the operating system in that computer. However, it is not necessary to distribute such software that includes modules as long as a typical platform is used, and the software itself that does not include such modules, as well as a storage medium on which such software is recorded (and, in the case where the software is distributed over a network, a data signal), can be thought of as configuring the embodiment.

Furthermore, the various constituent elements in the control unit 10 shown in FIG. 3 may be configured through software, or may be configured through dedicated large-scale integration (LSI) or similar hardware.

### Second Embodiment

1. Configuration of Activity Meter

The external configuration of the activity meter according to the present embodiment can be same as that of the activity meter 1 described in the first embodiment.

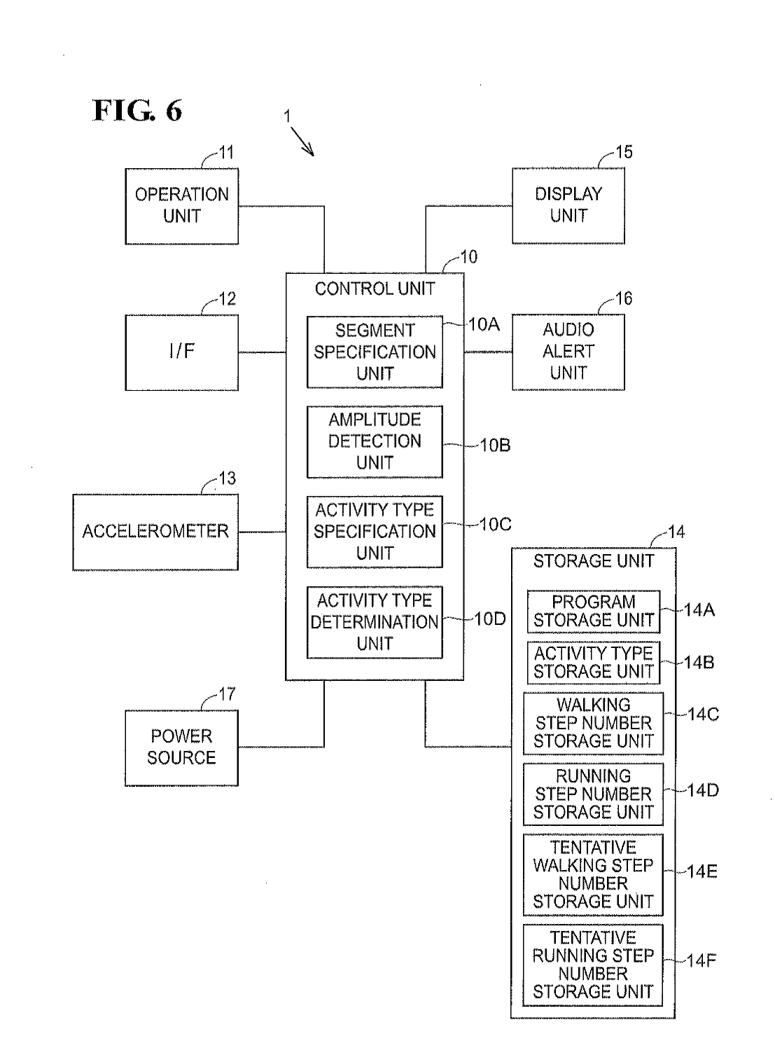

FIG. 6 is a block diagram illustrating the activity meter 1 according to the present embodiment.

As shown in FIG. 6, in the activity meter 1 according to the present embodiment, the control unit 10 includes an activity type determination unit 10D in addition to the segment specification unit 10A, the amplitude detection unit 1013, and the activity type specification unit 10C. In the step number management process, which will be described later, the activity type determination unit 10D tentatively determines the type of an activity for each segment that expresses a signal change resulting from one step's worth of body movement. The control unit 10 implements the functions of the stated various elements by, for example, the stated microprocessor executing the programs stored in the program storage unit 14A. Note that at least part of the control unit 10 may be realized by independent hardware resources.

The storage unit 14 according to the present embodiment includes a tentative walking step number storage unit 14E and a tentative running step number storage unit 14F in addition to the program storage unit 14A, the activity type storage unit 14B, the walking step number storage unit 14C, and the running step number storage unit 14B. The tentative walking step number storage unit 14E stores a number tentatively set to “walking” by the activity type determination unit 10D, whereas the tentative running step number storage unit 14F stores a number tentatively set to “running”.

2. Step Number Management Process

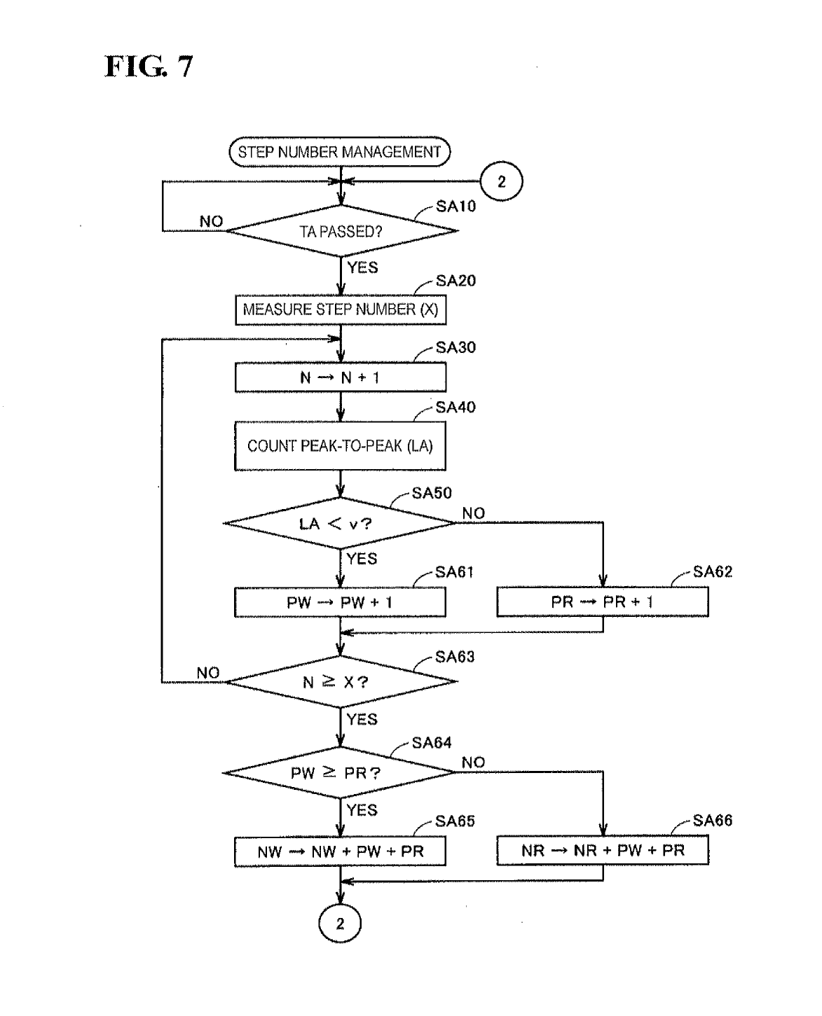

Next, a step number management process executed by the control unit 10 of the activity meter 1 according to the present embodiment will be described with reference to FIG. 7, which is a flowchart illustrating this process.

As shown in FIG. 7, in the step number management process, the control unit 10 first determines, in step SA10, whether a predetermined set amount of time (TA) has passed following the start of the step number management process or following the execution of the previous step SA65 or step SA66, and advances the process to step SA20 if it has been determined that the set amount of time has passed.

In step SA20, the control unit 10 measures a step number (X) based on a detection signal from the accelerometer 13 during the most recent period TA, and advances the process to step SA30.

In step SA30, the control unit 10 updates the variable N used in the step number management process by adding 1 thereto, and then advances the process to step SA40.

In step SA40, the control unit 10 detects a peak-to-peak amplitude (LA) for the Nth step in the detection signal from the accelerometer 13 in the most recent TA, and advances the process to step SA50.

In step SA50, it is determined whether or not LA measured in the previous step SA40 is less than a predetermined threshold v; if it is determined that LA is less than v, the process is advanced to step SA61, whereas if it is determined that LA is greater than or equal to v, the process advances to step SA62.

In step SA61, the control unit 10 updates a tentative walking step number PW stored in the tentative walking step number storage unit 14E by adding 1 to the tentative walking step number PW, and advances the process to step SA63.

On the other hand, in step SA62, the control unit 10 updates a tentative running step number PR stored in the tentative running step number storage unit 14F by adding 1 to the tentative running step number PR, and advances the process to step SA63.

In step SA63, it is determined whether or not the variable N has reached the step number (X) measured in step SA20; if it is determined that the variable N has not reached the step number (X), the process is returned to step SA30, whereas if it is determined that the variable N has reached the step number (X), the process is returned to step SA64.

In step SA64, the control unit 10 determines whether or not the tentative walking step number PW stored in the tentative walking step number storage unit 14E is greater than or equal to the tentative running step number PR stored in the tentative running step number storage unit 14F, and if the determination is positive, the process is advanced to step SA65. However, if PW is determined to be less than PR, the process is advanced to step SA66.

In step SA65, the control unit 10 updates the walking step number NW stored in the walking step number storage unit 14C by adding, to that walking step number NW, the walking step number (the tentative walking step number PW stored in the tentative walking step number storage unit 14E) and the running step number (the tentative running step number PR stored in the tentative running step number storage unit 14F) detected in the most recent period TA, and returns the process to step SA10.

On the other hand, in step SA66, the control unit 10 updates the running step number NR stored in the running step number storage unit 14D by adding, to that running step number NR, the tentative walking step number PW and the tentative running step number PR in the most recent period TA, and returns the process to step SA10.

In the step number management process according to the present embodiment described above, the type of the activity is tentatively determined to be walking or running for each segment by comparing the stated amplitude LA with the threshold v in each period TA. The tentative walking step number PW and the tentative running step number PR in the period TA are then compared; if the tentative walking step number PW is greater than or equal to the tentative running step number PR, all of the steps (that is, the sum of the tentative walking step number PW and the tentative running step number PR) counted during that period TA are taken as being of the “walking” activity type, and the walking step number NW in the walking step number storage unit 14C is updated accordingly. On the other hand, if the tentative walking step number PW is less than the tentative running step number PR, all of the steps (that is, the sum of the tentative walking step number PW and the tentative running step number PR) counted during that period TA are taken as being of the “running” activity type, and the running step number NR in the running step number storage unit 14D is updated accordingly.

When the process is returned from step SA65 or step SA66 to step SA10, the values of the tentative walking step number PW in the tentative walking step number storage unit 14E and the tentative running step number PR stored in the tentative running step number storage unit 14F are cleared.

Furthermore, the values of the walking step number NW stored in the walking step number storage unit 14C and the running step number NR stored in the running step number storage unit 14D are cleared under the condition that a switch for clearing those values, provided in the operation unit 11, has been operated.

Although two types of activities, or “walking” and “running”, are specified in the present embodiment, the present invention is not limited thereto. The configuration may be such that two types of thresholds are provided in step SA50, an activity type is tentatively determined as one of three types, or “running”, “walking”, and “strolling”, in order from a higher amplitude down, and the storage unit 14 stores, independent from each other, the cumulative numbers of those three types of activities (for example, a strolling step number storage unit is further provided); here, the activity type whose tentatively-determined number is the highest of the three activity types in the period TA is specified, and the total of the numbers tentatively determined in the period TA is added and updated as the number of the activity type specified as being the highest.

### Third Embodiment

1. Configuration of Activity Meter

The external configuration of the activity meter according to the present embodiment can be same as that of the activity meter 1 according to the first embodiment.

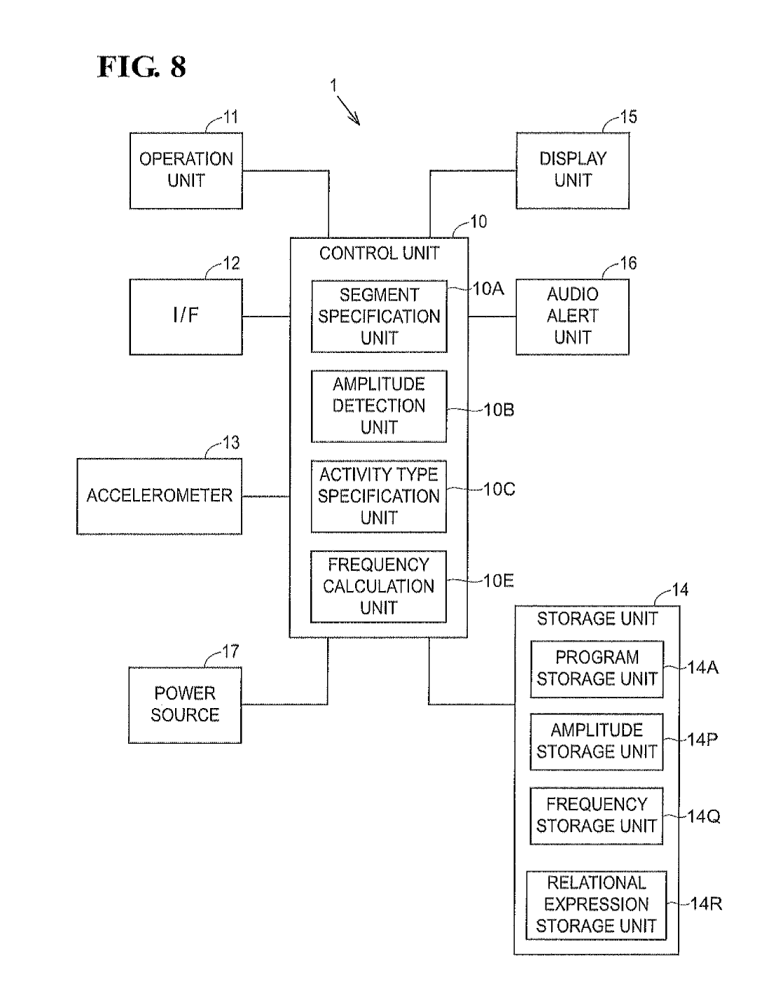

FIG. 8 is a block diagram illustrating the activity meter 1 according to the present embodiment.

In the activity meter 1 according to the present embodiment, the control unit 10 includes a frequency calculation unit 10E in addition to the segment specification unit 10A, the amplitude detection unit 10B, and the activity type specification unit 10C. Meanwhile, the storage unit 14 of the activity meter 1 according to the present embodiment includes an amplitude storage unit 14P, a frequency storage unit 14Q, and a relational expression storage unit 14R, in addition to the program storage unit 14A, the activity type storage unit 14B, the walking step number storage unit 14C, and the running step number storage unit 14D. The control unit 10 implements the functions of the stated various elements by, for example, the stated microprocessor executing the programs stored in the program storage unit 14A. Note that at least part of the control unit 10 may be realized by independent hardware resources.

In a step number management process described later, the amplitude storage unit 14P stores an amplitude LA for each segment. In the step number management process described later, the frequency storage unit 14Q stores the inverse of the number of segments (that is, a frequency) expressing a signal change resulting from one step's worth of body movement for each set period (the period TA, described later). Note that this frequency is calculated by the frequency calculation unit 10E. The relational expression storage unit 14R stores a relational expression for the frequency and the amplitude, described later.

2. Relationship between Frequency and Amplitude When Walking and When Running

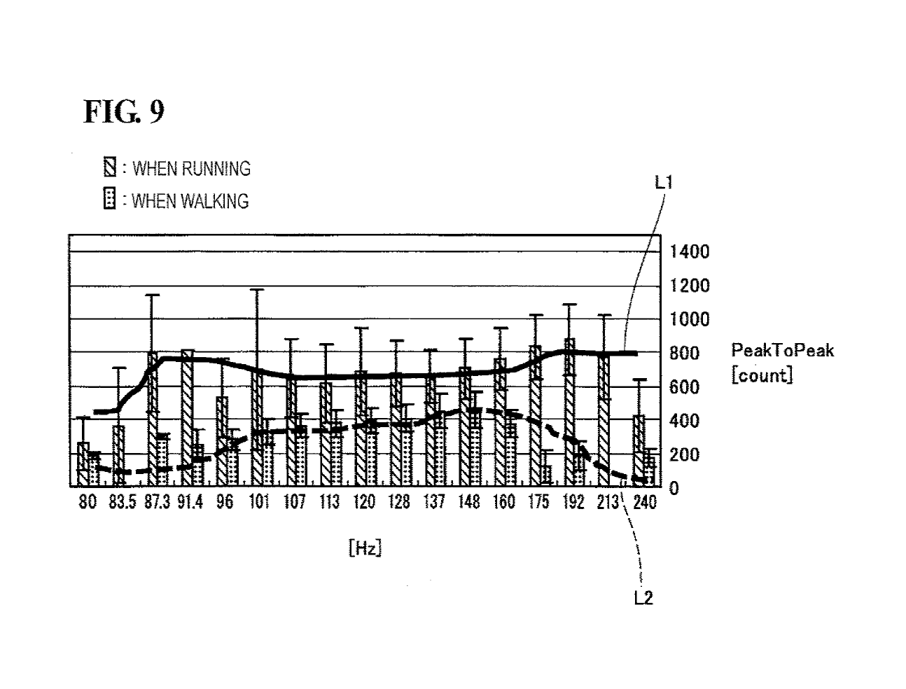

FIG. 9 is a diagram illustrating the stated frequency when walking and when running, and the amplitude LA of the detection output from the accelerometer 13 for the frequency in one step's worth of body movement, in the activity meter 1. Note that the relationship shown in FIG. 9 is merely one example of the relationship between the frequency and the amplitude, and that graphs L1 and L2 represent the averages of measurements taken for multiple people (or the average of measurements taken at multiple times) with such a relationship. The graph L1 corresponds to results when running, whereas the graph L2 corresponds to results when walking. Measurement results such as those shown in FIG. 9 are assumed to be obtained when the activity meter 1 is operating in a mode for learning activity types (for example, a learning mode).

As shown in FIG. 9, it can be said that if any of the frequencies are the same frequency, there is a tendency for the amplitude LA to be greater when running than when walking.

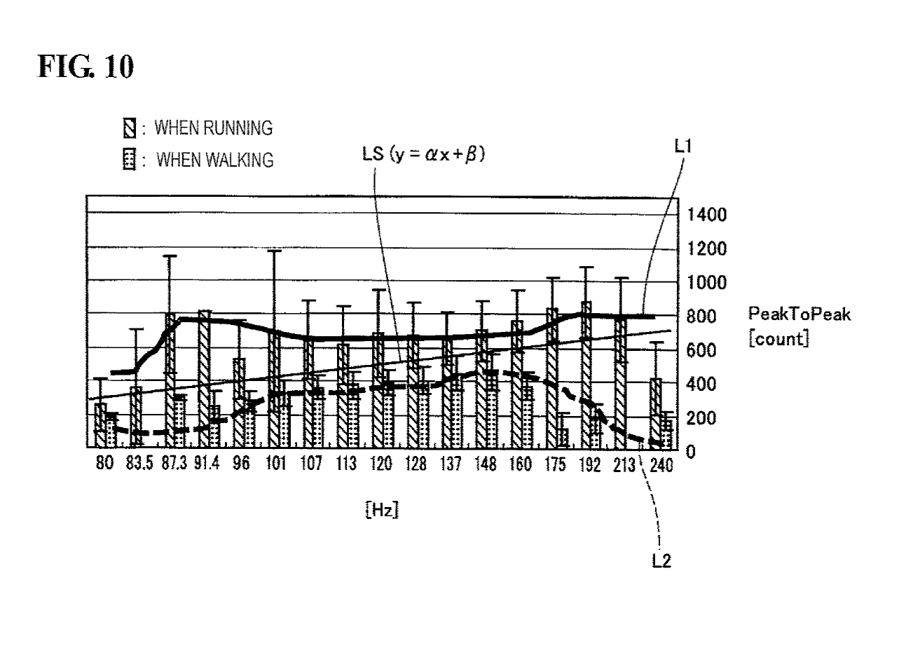

Accordingly, in the case where each frequency is taken as a reference, a straight line, such as that indicated as a line LS in FIG. 10, can be used to divide the results into regions corresponding to the results obtained when running and the results obtained when walking.

Note that the line LS can be expressed by the following Equation (1) in the case where the amplitude LA is taken as y and the frequency is taken as x. α and β in Equation (1) are constants set as appropriate in each activity meter 1, In Equation (1), y is equivalent to β being added to the product of α and x.

y=αx+β (1)

The equation for the line LS (Equation (1)) is stored in the relational expression storage unit 14R.

Based on this, in the present embodiment, it is specified whether the activity type is walking or running for each segment expressing a change in the signal from the accelerometer 13 resulting from one step's worth of body movement.

3. Step Number Management Process

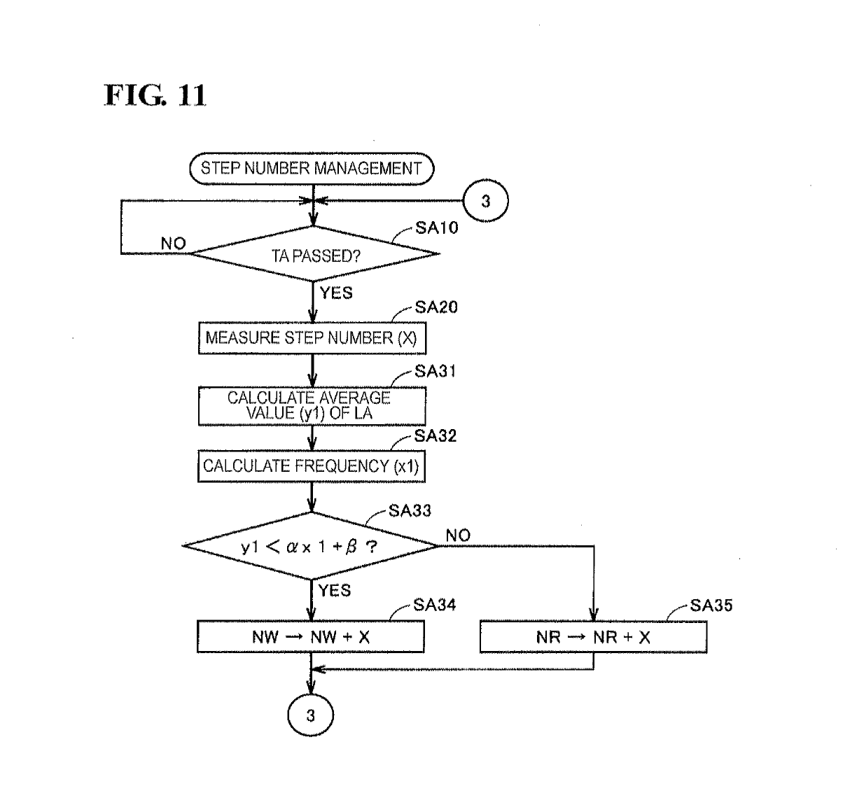

As shown in FIG. 11, in the step number management process according to the present embodiment, the control unit 10 first determines, in step SA10, whether a predetermined amount of time (TA) has passed following the start of the step number management process or following the execution of the previous step SA34 or step SA35, and advances the process to step SA20 if it has been determined that the set amount of time has passed.

In step SA20, the control unit 10 measures a step number (X) for a detection signal from the accelerometer 13 during the most recent period TA, and advances the process to step SA31.

In step SA31, the control unit 10 detects the amplitude LA for all step numbers in the most recent period TA, calculates an average value (y1) thereof, and advances the process to step SA32, Note that in step SA31, the control unit 10 stores the average value y1 of LA in the amplitude storage unit 14P.

In step SA32, the control unit 10 calculates the inverse number of the step number X measured in step SA20, calculates a frequency x1 by multiplying the periods TA by that inverse number, and advances the process to step SA33.

In step SA33, the control unit 10 determines whether or not y1 calculated in step SA31 and x1 calculated in step SA32 fulfill the relationship expressed by the following Equation (2). In other words, it is determined whether or not y1 is less than a value obtained by adding β to the product of α and x1.

y1<α·x1+β (2)

Note that the control unit 10 can carry out the process of step SA33 by reading out Equation (1) stored in the relational expression storage unit 14R, substituting y1 calculated in step SA31 for y in Equation (1), substituting x1 calculated in step SA32 for x in Equation (1), and changing the equal sign in Equation (1) to an inequality sign.

Then, in step SA33, the control unit 10 advances the process to step SA34 if it is determined that the relationship in Equation (2) holds true, and advances the process to step SA35 if it is determined that the relationship does not hold true, or in other words, if y1 calculated in step SA31 is greater than or equal to α·x1+β.

In step SA34, the step number X measured for the most recent period TA is taken as corresponding in its entirety to the activity type “walking”, and the control unit 10 accordingly updates the walking step number NW stored in the walking step number storage unit 14C by adding X thereto and returns the process to step SA10.

On the other hand, in step SA35, the step number X measured for the most recent period TA is taken as corresponding in its entirety to the activity type “running”, and the control unit 10 accordingly updates the running step number NR stored in the running step number storage unit 14D by adding X thereto and returns the process to step SA10.

Note that in step SA34 and step SA35, the step number X, the average value y1 of the amplitude stored in the amplitude storage unit 14P, and the frequency x1 stored in the frequency storage unit 14Q are all cleared.

With the step number management process according to the present embodiment described thus far, in the measurement mode, the number of steps is calculated for each period TA; the amplitude LA is calculated for each segment expressing a signal change resulting from one step's worth of body movement in the detection signal from the accelerometer 13; the total (y1) of those amplitudes L.A. is calculated; and the frequency (x1) is calculated for the step number X.

Then, it is determined which region, among regions divided according to a predetermined relational expression, y1 and x1 belong to. In terms of Equation (2), if y1<α·x1+β holds true, the coordinates expressed by y1 and x1 fall into the region below the line LS (see FIG. 10), or in other words, belong to the region on the “walking” side. However, if y1≧α·x1+β holds true, the coordinates expressed by y1 and x1 fall into the region above the line LS (see FIG. 10), or in other words, belong to the region on the “running” side.

The stated relational expression is, as described with reference to FIG. 9 and FIG. 10, a relational expression capable of separating regions based on the details of the activity, in the case where a graph has been created based on the frequency and amplitude of the detection output from the accelerometer 13. The relational expression can, when for example the activity meter 1 is operated in the learning mode, be created based on the detection signal from the accelerometer during operation in the learning mode, and can then be stored.

In the present embodiment, it is then determined, based on whether the coordinates expressed by y1 and x1 belong to the region on the “walking” side or belong to the region on the “running” side, whether the activity type in the one step's worth of body movement corresponding to those values is “walking” or “running”.

Although the relational expression in the present embodiment is a straight line equation as indicated by Equation (1), the present invention is not limited thereto. For example, the relational expression may be a quadratic function, a cubic function, or the like.

### Fourth Embodiment

1. Configuration of Activity Meter

The external configuration of the activity meter according to a fourth embodiment of the present invention can be same as that of the activity meter 1 according to the first embodiment.

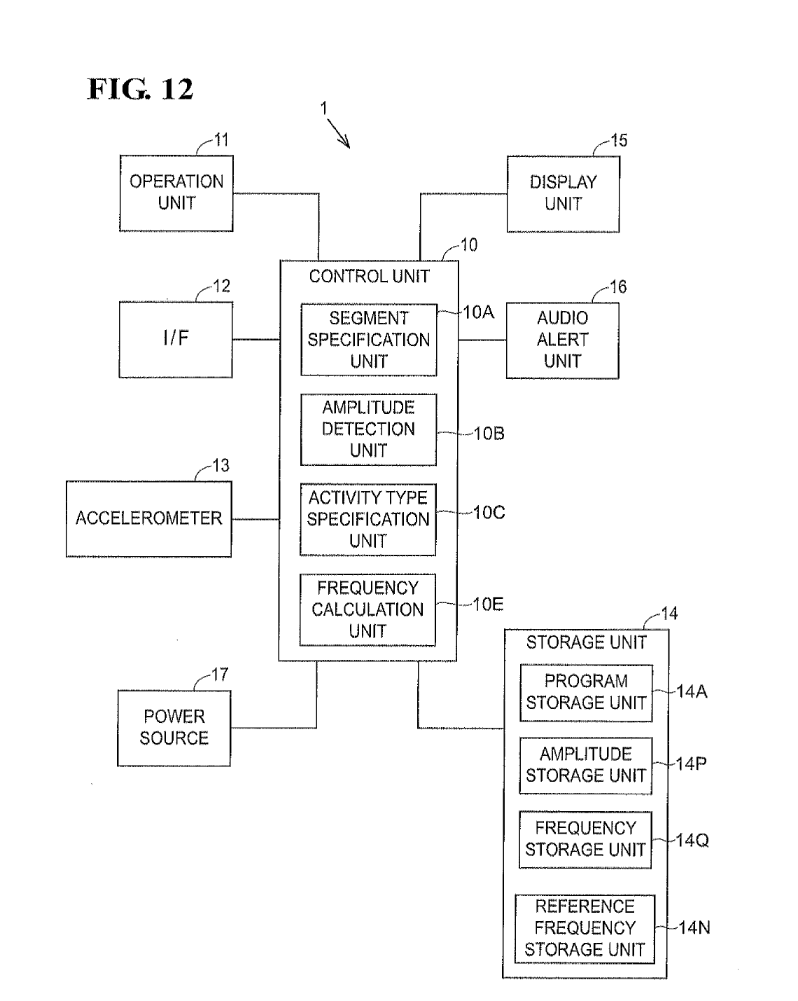

FIG. 12 is a block diagram illustrating the activity meter 1 according to the fourth embodiment of the present invention.

As shown in FIG. 12, with the activity meter 1 according to the present embodiment, the control unit 10 includes the frequency calculation unit 10E in addition to the segment specification unit 10A, the amplitude detection unit 10B, and the activity type specification unit 10C. The control unit 10 implements the functions of the stated various elements by, for example, the stated microprocessor executing the programs stored in the program storage unit 14A. Note that at least part of the control unit 10 may be realized by independent hardware resources.

In the activity meter 1 according to the present embodiment, the storage unit 14 includes the amplitude storage unit 14P, the frequency storage unit 14Q, and a reference frequency storage unit 14N, in addition to the program storage unit 14A, the activity type storage unit 14B, the walking step number storage unit 14C, and the running step number storage unit 14D.

The reference frequency storage unit 14N stores a reference value for a relationship between a frequency and an amplitude obtained based on a result of operating the activity meter 1 in the learning mode, as described with reference to FIG. 9 and FIG. 10. Specifically, the reference frequency storage unit 14N stores at least a reference value for amplitudes at each frequency during running.

2. Step Number Management Process

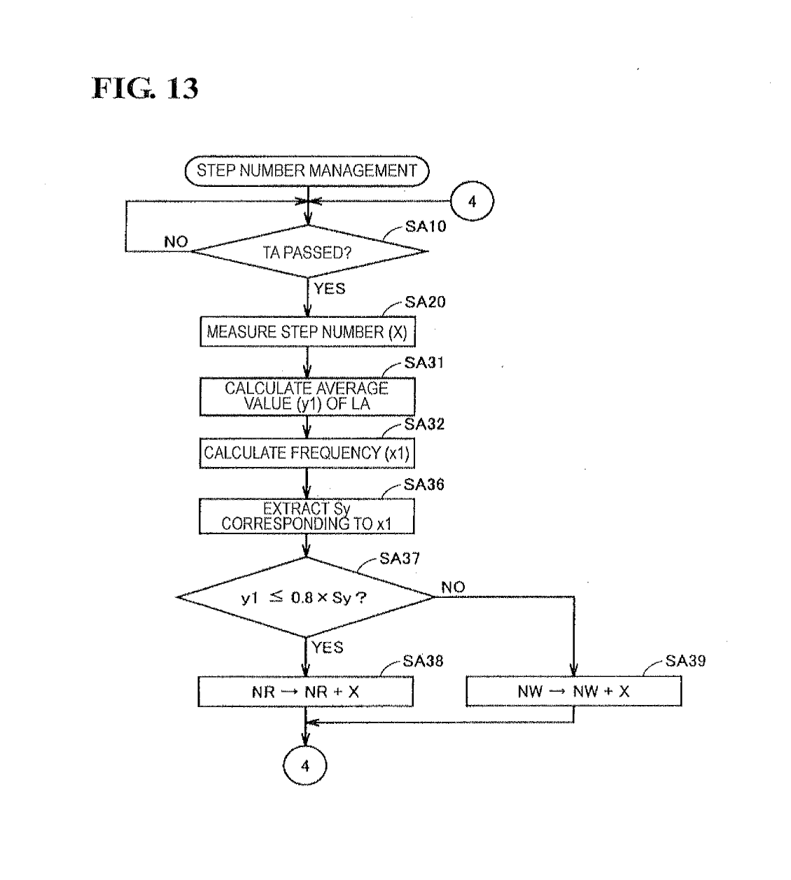

Next, a step number management process executed by the control unit 10 according to the present embodiment will be described with reference to FIG. 13, which is a flowchart illustrating this process.

As shown in FIG. 13, in the step number management process, the control unit 10 first determines, in step SA10, whether a predetermined period (TA) has passed following the start of the step number management process or following the execution of the final step SA38 or step SA39, and advances the process to step SA20 if it has been determined that the period has passed.

In step SA20, the control unit 10 executes a process for measuring a step number (X) for a detection signal from the accelerometer 13 during the most recent period TA, and advances the process to step SA31.

In step SA31, the control unit 10 detects the amplitude LA, as described with reference to FIG. 5, for all of the step numbers measured in step SA20, calculates an average value (y1) for all of the amplitudes LA, and advances the process to step SA32.

In step SA32, the control unit 10 converts the step number X in the period TA into a frequency (x1), and advances the process to step SA36.

In step SA36, the control unit 10 extracts an amplitude (Sy) stored in the reference frequency storage unit 14N in association with the frequency x1 obtained in step SA32, and advances the process to step SA37.

In step SA37, the control unit 10 determines whether or not y1 calculated in step SA31 and the amplitude reference value Sy extracted in step SA36 fulfill the relationship in the following Equation (3). In other words, it is determined whether or not y1 is greater than or equal to the product of 0.8 and Sy.

y1≧0.8·Sy (3)

Note that the process in step SA37 corresponds to a process for determining whether or not y1 is a value greater than or equal to 80% of Sy.

The control unit 10 advances the process to step SA38 if it is determined that Equation (3) holds true, and advances the process to step SA39 if it is determined that Equation (3) does not hold true, or in other words, if it is determined that y1 is less than 80% of Sy.

In step SA38, all of the step numbers X in the most recent TA are taken as belonging to the activity type “running”, and the control unit 10 updates the running step number NR stored in the running step number storage unit 14D by adding X thereto and returns the process to step SA10.

On the other hand, in step SA39, all of the step numbers X in the most recent period TA are taken as belonging to the activity type “walking”, and the control unit 10 updates the walking step number NW stored in the walking step number storage unit 14C by adding X thereto and returns the process to step SA10.

Note that in step SA38 and step SA39, the step number X, which is the result of the measurement performed in step SA20, is cleared.

According to the present embodiment described thus far, a reference value for the amplitude of the signal from the accelerometer resulting from one step's worth of body movement (that is, the difference between the maximum value and the minimum value of the detection output from the accelerometer in a segment determined to be a segment corresponding to one cycle's worth of body movement) is stored in association with the frequency of that body movement. Then, in the actual measurement mode, a frequency within the predetermined period TA is calculated, the amplitude stored in association with that frequency is read out, and that amplitude is compared with the amplitude (y1) that is the actual detection result. The activity type to which the number of steps calculated in the period that is being processed belongs is then determined based on the result of that comparison.

According to the embodiments described above, the type of an activity in a predetermined period including segments corresponding to single cycles of body movement determined based on the detection output from an accelerometer is specified based on the difference between the maximum value and the minimum value of the detection output from the accelerometer in those segments. Through this, the activity type can be more accurately specified even in cases where the user is running comparatively slowly and where the user is running comparatively quickly; furthermore, the accuracy of the activity type specification can be improved even in the case where there has been a change in the direction of the acceleration detected by the activity meter (resulting from, for example, the activity meter being placed in a purse or the like).

Note that the embodiments disclosed above are to be understood as being in all ways exemplary and in no way limiting. The scope of the present invention is defined not by the aforementioned descriptions but by the scope of the appended claims, and all changes that fall within the same essential spirit as the scope of the claims are intended to be included therein as well. The aforementioned embodiments can also be carried out in any possible combinations with each other.

### REFERENCE SIGNS LIST

1 activity meter
10 control unit
10A segment specification unit
10B amplitude detection unit
10C activity type specification unit
10D activity type determination unit
10E frequency calculation unit
11 operation unit
13 accelerometer
14 storage unit
14A program storage unit
14B activity type storage unit
14C walking step number storage unit
14D running step number storage unit
14E tentative walking step number storage unit
14F tentative running step number storage unit
14P amplitude storage unit
14Q frequency storage unit
14R relational expression storage unit
14N reference frequency storage unit

1. An activity meter comprising:
an accelerometer for detecting movement of a body; and
a control unit connected to the accelerometer,
wherein the control unit:
determines segments corresponding to single cycles of body movement based on a detection output from the accelerometer;
based on a difference between a maximum value and a minimum value in the detection output from the accelerometer that correspond to the determined segments of the single cycles, specifies a type of activity performed in a predetermined period that includes the segments;
tentatively determines the type of activity performed in the segments; and
determines that the type of activity that has been tentatively determined most often in the segments in the predetermined period is the type of activity in all the segments in the predetermined period.

2. The activity meter according to claim 1,
wherein when tentatively determining the type of activity, the control unit tentatively determines the type of activity in the segments to be walking or running using a threshold for the difference between the maximum value and the minimum value.

3. An activity meter comprising:
an accelerometer for detecting movement of a body; and
a control unit connected to the accelerometer,
wherein the control unit:
determines segments corresponding to single cycles of body movement based on a detection output from the accelerometer;
based on a difference between a maximum value and a minimum value in the detection output from the accelerometer that correspond to the determined segments of the single cycles, specifies a type of activity performed in a predetermined period that includes the segments;
calculates a frequency regarding the body movement by calculating the inverse number of the number of segments per unit of time; and
specifies the type of activity based on the difference between the maximum value and minimum value and the frequency.

4. The activity meter according to claim 3, further comprising:
a storage unit that stores a relational expression for distinguishing the type of activity based on the difference between the maximum value and minimum value and the frequency,
wherein the control unit specifies the type of activity using the actual values of the difference between the maximum value and minimum value and the frequency, and the relational expression.

5. The activity meter according to claim 3, further comprising:
a storage unit that stores a reference value for the difference between the maximum value and minimum value, the reference value being associated with the frequency,
wherein the control unit specifies the activity type based on whether or not the difference between the maximum value and minimum value in the determined segments of the single cycles fulfills a specific condition relative to the reference value, stored in the storage unit, for the difference between the maximum value and minimum value associated with the calculated frequency.

6. A control method for an activity meter including an accelerometer for detecting movement of a body, the method comprising:
a step of the activity meter determining segments corresponding to single cycles of body movement based on a detection output from the accelerometer; and
a step of the activity meter specifying, based on a difference between a maximum value and a minimum value in the detection output from the accelerometer that correspond to the determined segments of the single cycles, a type of activity performed in a predetermined period that includes the segments,
wherein the step of specifying the type of activity performed in the predetermined period includes:
a step of tentatively determining the type of activity performed in the segments; and
a step of determining that the type of activity that has been tentatively determined most often in the segments in the predetermined period is the type of activity in all the segments in the predetermined period.

7. A storage medium in which is stored a control program executed by a computer of an activity meter including an accelerometer for detecting movement of a body, the control program causing the computer of the activity meter to execute:
a step of determining segments corresponding to single cycles of body movement based on a detection output from the accelerometer; and
a step of specifying, based on a difference between a maximum value and a minimum value in the detection output from the accelerometer that correspond to the determined segments of the single cycles, a type of activity performed in a predetermined period that includes the segments,
wherein the step of specifying the type of activity performed in the predetermined period includes:
a step of tentatively determining the type of activity performed in the segments; and
a step of determining that the type of activity that has been tentatively determined most often in the segments in the predetermined period is the type of activity in all the segments in the predetermined period.
